(19) United States
(12) Patent Application Publication
(10) Pub. No.: US 2024/0125980 A1
(43) Pub. Date: Apr. 18, 2024

(54) OPTICAL DEVICES INCLUDING AN OPTICAL LAYER ON A SUBSTRATE

(71) Applicant: NILT Switzerland GmbH, Horgen (CH)

(72) Inventor: Niklas HANSSON, Kongens Lyngby (DK)

(21) Appl. No.: 18/277,645

(22) PCT Filed: Feb. 17, 2022
(86) PCT No.: PCT/EP2022/053923

§ 371 Date: Aug. 17, 2023

Related U.S. Application Data
(60) Provisional application No. 63/152,093, filed on Feb. 22, 2021.

(51) Int. Cl. G02B 1/14; F21V 8/00

(52) U.S. Cl. CPC G02B 1/14; G02B 6/0038; G02B 6/136

(57) ABSTRACT

An optical device includes a substrate and an optical layer disposed on the substrate. In some implementations, a surface of the substrate that forms an interface with the optical layer is non-planar, and an overall surface area of the interface is greater than if the surface of the substrate were planar. Adhesion of the optical layer to the substrate can, at least in some cases, be improved by the higher surface area of the interface.

### FIELD OF THE DISCLOSURE

The present disclosure relates to devices that include an optical layer disposed on a substrate, and to methods of fabricating such devices.

### BACKGROUND

Thin layers of optical material can be applied to glass, silicon and other substrates to fabricate, for example, optical elements (e.g., lenses), mirrors, optical filters, beam splitters, or sensors. The optical layer(s) can be used to alter the optical properties of system components, for example, by increasing or decreasing reflectance, transmittance, absorptance or polarization. Depending on the application, there may be a single layer or multiple layers of optical material on the substrate.

The integrity of the optical layers depends on their chemical and mechanical properties. Among other things, the optical layer(s) must adhere to the substrate. In some cases, however, intrinsic strain in the materials stores mechanical energy that can cause at least partial delamination of the optical layer(s) from the substrate. Such delamination can be a particular concern when multiple optical devices (e.g., lenses) are fabricated on a single substrate (e.g., a wafer) and subsequently are singulated by dicing. For example, mechanical blade dicing sometimes is used for to separate the individual optical elements on a die from one another. Poor adhesion or delamination of the thin optical layers sometimes is a key failure mode in packaging processes, including wafer dicing.

### SUMMARY OF THE DISCLOSURE

The present disclosure describes various techniques that, in some implementations, can help improve adhesion of an optical layer to a substrate. For example, structural features can be provided, in some implementations, adjacent a region established for dicing tracks of a substrate wafer so as to increase the overall surface area of the interface between the optical layer and the adjacent layer(s). After separating the individual devices from one another (e.g., by dicing), a residual dicing track region of each device (e.g., a region adjacent a lateral side-surface of the device) includes at least some of the structural features. Thus, in some implementations, the structural features can be present, for example, in an optically inactive area of the device that is adjacent the periphery of the device and that surrounds the device's optically active area. The increased surface area between the optical layer and the adjacent layer(s) in the resulting devices can, in at least some implementations, reduce the likelihood of delamination of the optical layer.

In one aspect, for example, the present disclosure describes an optical device that includes a substrate and an optical layer disposed on the substrate. A surface of the substrate that forms an interface with the optical layer is non-planar, and an overall surface area of the interface is greater than if the surface of the substrate were planar.

Some implementations include one or more of the following features. For example, in some instances, a first region of the substrate has a first thickness, and a second region of the substrate adjacent a lateral side-surface of the substrate has a second thickness that is less than the first thickness. In some cases, the second region of the substrate is below an optically inactive area of the optical layer. In some cases, the surface of the substrate in the second region is rougher than the surface of the substrate in the first region.

In some instances, the surface of the substrate includes one or more trenches. The one or more trenches can be, for example, in a region of the substrate adjacent a lateral side-surface of the substrate. In some cases, the one or more trenches include at least one undercut trench. In some cases, the one or more trenches include at least one straight-walled trench. In some cases, the one or more trenches include at least one curved-walled trench. In some cases, the trenches include at least one canted straight-walled trench. In some cases, there are multiple trenches, wherein a volume of at least one of the trenches differs from a volume of another one of the trenches.

In some instances, the surface of the substrate includes a projection located closer to a lateral side-surface of the substrate than are the one or more trenches, and a height of the projection is less than a depth of the one or more trenches.

In another aspect, the present disclosure describes an optical device that includes a substrate and one or more projections on a surface of the substrate. The one or more projections can be composed, for example, of a silicon film. An optical layer is disposed on the surface of the substrate and on surfaces of the projections. The optical layer has a first region that is structured so as to provide an optical effect on light impinging on the first region. The optical layer further includes a second optically inactive region that is closer to a lateral side-surface of the substrate, wherein the one or more projections are disposed below the second optically inactive region of the optical layer.

Some implementations include one or more of the following features. For example, the substrate can be composed of glass, and the optical layer can be composed of a polymeric material. In some instances, each of the one or more projections has a shape of an inverted frustum of a pyramid.

In some cases, the substrate is composed of glass or silicon, and the optical layer is composed of a polymeric material.

The present disclosure also describes methods of manufacturing the optical devices.

The present disclosure further describes an optoelectronic assembly that includes an optoelectronic component, a housing, and an optical device. The optical device is aligned with the optoelectronic component and is mounted to the housing.

In some implementations, the presence of the structural features in or on the substrate can help reduce the likelihood of delamination of the optical layer during, and subsequent to, fabrication of the devices. Thus, the techniques described in this disclosure can, in some instances, improve adhesion of the optical layer to the underlying substrate.

Other aspects, features and advantages will be apparent from the following detailed description, the accompanying drawings, and the claims.

### BRIEF DESCRIPTION OF THE DRAWINGS

FIG. 1 illustrates a top view of an optical element.

FIG. 2 is a first example of a cross-section of an optical element taken along line A-A of FIG. 1.

FIG. 3 is a second example of a cross-section of an optical element taken along line A-A of FIG. 1.

FIG. 4 is a third example of a cross-section of an optical element taken along line A-A of FIG. 1.

FIG. 5 is a fourth example of a cross-section of an optical element taken along line A-A of FIG. 1.

FIG. 6 is a fifth example of a cross-section of an optical element taken along line A-A of FIG. 1.

FIG. 7 is a sixth example of a cross-section of an optical element taken along line A-A of FIG. 1.

FIG. 8 illustrates an example of an optoelectronic module.

FIG. 9 is a seventh example of a cross-section of an optical element taken along line A-A of FIG. 1.

FIG. 10A illustrates an example of an optoelectronic module incorporating the optical element of FIG. 9.

FIG. 10B shows an enlarged view of a portion of the module of FIG. 10A.

FIG. 11 is an eighth example of a cross-section of an optical element taken along line A-A of FIG. 1.

FIGS. 12A-12C illustrate a method of fabricating optical elements as in FIG. 2.

FIG. 13 is a top view of a substrate wafer including multiple optical elements thereon.

FIGS. 14A-14C illustrate a method of fabricating optical elements as in FIG. 3.

FIGS. 15A-15C illustrate a method of fabricating optical elements as in FIG. 4.

FIGS. 16A-16C illustrate a method of fabricating optical elements as in FIG. 5.

FIGS. 17A-17C illustrate a method of fabricating optical elements as in FIG. 6.

FIGS. 18A-18C illustrate a method of fabricating optical elements as in FIG. 7.

FIGS. 19A-19E illustrate a method of fabricating optical elements as in FIG. 11.

### DETAILED DESCRIPTION

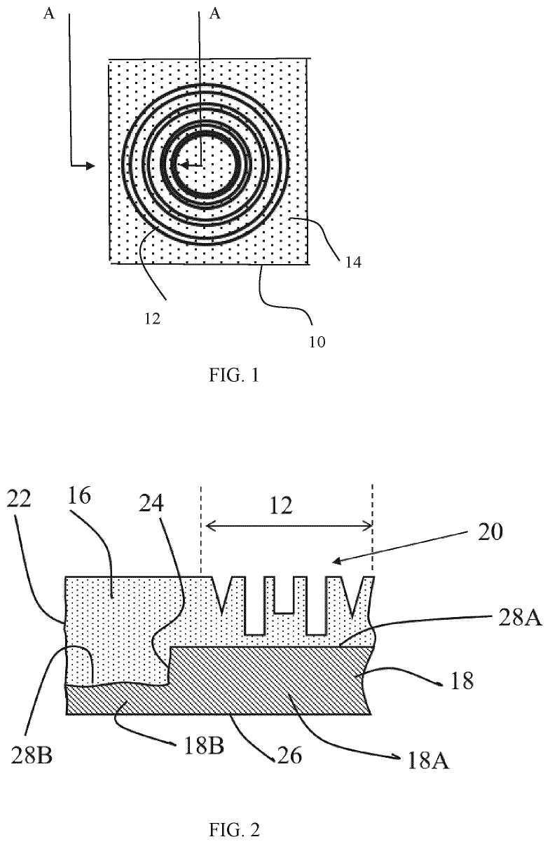

As shown in the example of FIG. 1, an optical element 10 includes an optically active area 12 and a residual dicing track region 14 that laterally surrounds the optically active area. The residual dicing track region 14 can be, for example, an optically inactive area laterally surrounding the optically active area 12. As illustrated in each of the examples of FIGS. 2-7, 9 and 11, the optical element 10 includes an optical layer 16 on a substrate 18.

The substrate 18 can be composed, for example of glass, silicon (e.g., polysilicon or crystalline), or another suitably rigid material that serves as a support for the optical layer. The optical layer 16 can be composed, for example, of a polymeric material (e.g., a micro resist. In some cases, the optical layer 16 is applied to the substrate 18 by a spin-on technique, by jetting, or by drip-casting.

The surface 20 of the optical layer 16 that faces away from the substrate 18 may be substantially planar. However, in some implementations, the surface 20 can be structured so to provide one or more optical functions (e.g., refraction, diffraction, polarization control, negative refractive index transmission, beam deflection, vortex generation, polarization conversion, or optical filtering). The optical structures can be formed, for example, by imprinting them into the surface 20. In some instances, the optical structures are formed by a nanoimprint lithographic process.

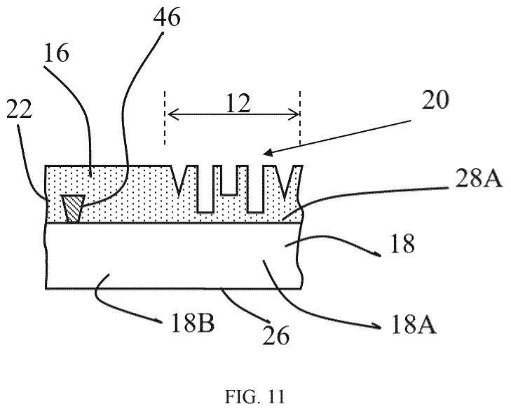

The interface between the optical layer 16 and the adjacent layer(s) includes structural features that can increase the overall surface area of the interface. The increase in overall surface area of the interface is relative to the surface area that would be present if the interface were substantially planar (i.e., without the structural features as described below). In some implementations, as described in greater detail below, the structural features can include trenches or other features etched into the surface of the substrate 18 (see, e.g., FIGS. 2-7 and 9). In some implementations, the structural features are formed on the surface of the substrate 18 (see, e.g., FIG. 11).

In some instances, one or more lateral side-surfaces 22 of the optical element 10 are cut or diced surfaces that result from singulation of the optical element during dicing of the wafer.

The optical element 10 can be, for example, a lens. In other implementations, the optical element 10 may function as a mirror, an optical filter, a beam splitter, an optical polarizer, or a sensor. Details of the optical layer 16 may depend on the intended functionality of the optical element 10.

As shown in the example of FIG. 2, a first region 18A of the substrate 18 below the optically active area 12 has a first thickness, whereas a second region 18B of the substrate 18 adjacent the lateral side-surfaces 22 has a second thickness that is less than the first thickness. The substrate 18 thus has a shoulder portion 24 that extends from the second region 18B to the first region 18A of the substrate 18. The shoulder 24 may, in some cases, be substantially straight and perpendicular to the lower surface 26 of the substrate 18. In some implementations, the upper surface 28B of the second region 18B of the substrate 18 can be rougher than the upper surface 28A of the first region 18A of the substrate 18. Each of the shoulder 24 and the surface 28B having the enhanced roughness can serve, separately or together, as structural features that can increase the overall surface area of the interface between the substrate 18 and the optical layer 16. The increased surface area can, in turn, help reduce the likelihood of delamination of the optical layer 16.

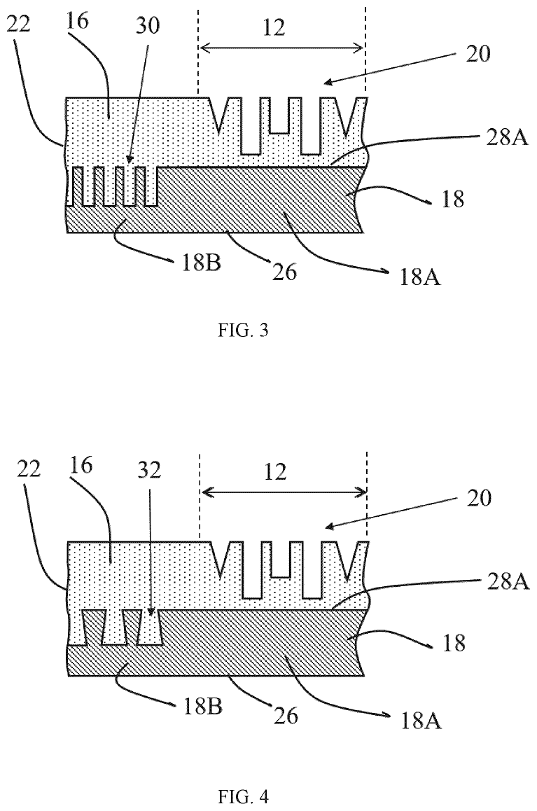

FIG. 3 illustrates another example of an optical element in which the structural features for increasing the overall surface area of the interface between the substrate 18 and the optical layer 16 include trenches 30 in the upper surface of the second region 18B of the substrate 18. That is, the substrate 18 includes one or more trenches 30 in the region 18B that is adjacent the lateral side-surfaces 22. In some case, the trenches 30 have substantially straight-vertical walls, although in other cases. As shown in FIG. 3, the trenches 30 are filled with the optical material of the optical layer 16.

FIG. 4 illustrates another example of an optical element in which the structural features for increasing the overall surface area of the interface between the substrate 18 and the optical layer 16 include undercut trenches 32 in the upper surface of the second region 18B of the substrate 18. That is, the substrate 18 includes one or more undercut trenches 32 in the region 18B that is adjacent the lateral side-surfaces 22. The trenches 32 can have substantially straight non-vertical walls such that the trenches are wider at their bottom than at their top. As shown in FIG. 4, the trenches 32 are filled with the optical material of the optical layer 16. The undercut shape of the trenches 32 can, in some instances, help prevent delamination of the optical layer 16.

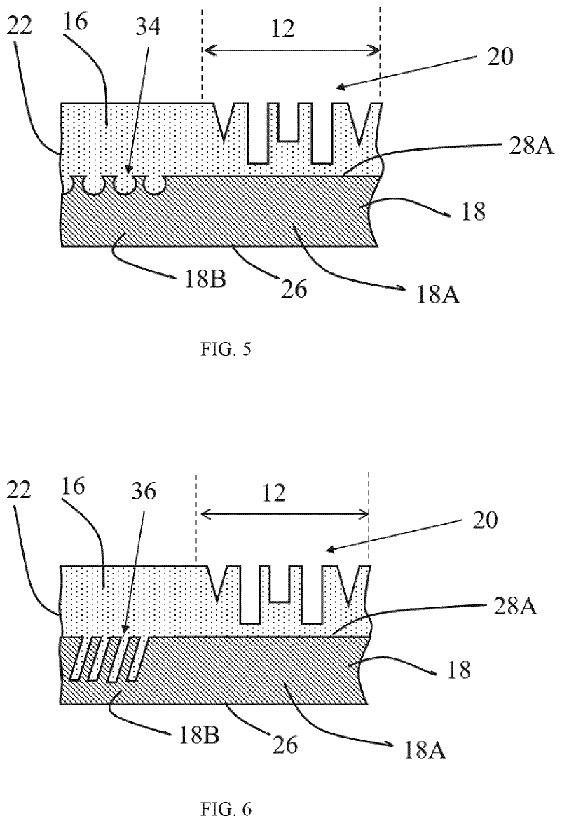

FIG. 5 illustrates yet another example of an optical element in which the structural features for increasing the overall surface area of the interface between the substrate 18 and the optical layer 16 include undercut trenches 34 in the upper surface of the second region 18B of the substrate 18. Here as well, the undercut trenches 34 are in the region 18B adjacent the lateral side-surfaces 22. In this example, however, the trenches 34 have curved walls. As shown in FIG. 5, the trenches 34 are filled with the optical material of the optical layer 16. The undercut shape of the trenches 34 can, in some instances, help prevent delamination of the optical layer 16.

FIG. 6 illustrates a further example of an optical element in which the structural features for increasing the overall surface area of the interface between the substrate 18 and the optical layer 16 include trenches 36 in the upper surface of the second region 18B of the substrate 18. The trenches 36 also are in the region 18B adjacent the lateral side-surfaces 22. In this example, however, the trenches 36 have canted straight walls (e.g., tilted with respect to the lower surface 26 of the substrate 18). As shown in FIG. 6, the trenches 36 are filled with the optical material of the optical layer 16. The tilted orientation of the trenches 32 can, in some instances, help prevent delamination of the optical layer 16 by counteracting the delamination torque.

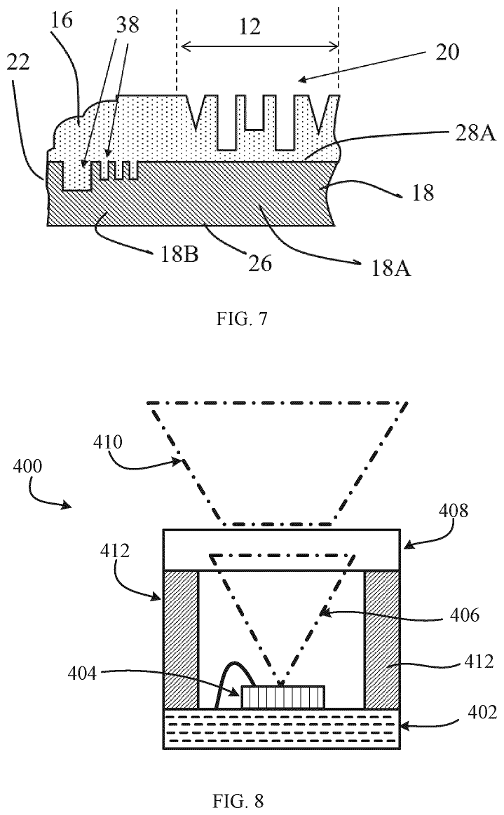

FIG. 7 illustrates another example of an optical element in which the structural features for increasing the overall surface area of the interface between the substrate 18 and the optical layer 16 include straight-walled trenches 38 in the upper surface of the second region 18B of the substrate 18. As in the previous examples, the trenches 38 are in the region 18B adjacent the lateral side-surfaces 22. In this example, however, the trenches 38 have different volumes from one another. That is, some of the trenches 38 may be deeper than other ones of the trenches 38, and/or some of the trenches 38 may have larger widths than other ones of the trenches 38. In the illustrated, trenches 38 closer to the lateral side-surface 22 have a larger volume than trenches closer to the first region 18B of the substrate 18. As shown in FIG. 7, the trenches 38 are filled with the optical material of the optical layer 16. This arrangement of trenches 38 can, in some instances, help prevent delamination of the optical layer 16.

An optical element as described in this disclosures may be integrated, for example, into optical or optoelectronic systems including a device that is operable to emit or sense light at an operational wavelength k. As shown in FIG. 8, a module 400 includes a substrate 402 and a light-emitting component 404 coupled to or integrated into the substrate 402. The light-emitting component 404 may include, for example, a laser (for example, a vertical-cavity surface-emitting laser), a light-emitting diode or a laser diode. Light (e.g., infra-red or visible) 406 generated by the light-emitting component 404 is transmitted through a housing and then to an optical device 408 (e.g., an optical element as described in this disclosure). The optical device 408 is operable to interact with the light 406, such that modified light 410 is transmitted out of the module 400. For example, in some implementations, the module 400, using the optical device 408, may produce one or more of structured light, diffused light, or patterned light. The housing may include, for example, spacers 412 separating the light-emitting component 404 and/or the substrate 402 from the optical device 408.

In some implementations, the light emitting component is mounted so as to direct incident light to the optical device 408, and the light emitting component is operable to emit the incident light of the operational wavelength and to generate the optical effect.

In some implementations, the module 400 of FIG. 8 is a light-sensing module (for example, an ambient light sensor), the component 404 is a light-sensitive component (for example, a photodiode, a pixel, or an image sensor), the light 406 is incident on the module 400, and the light 410 is modified by the optical device 408. For example, the optical device 408 (e.g., an optical element as described in this disclosure) may focus patterned light onto the light-sensitive component 404. In some implementations, the module 400 may including both light-emitting and light-sensing components. In some implementations, the light-sensitive component is operable to collect reflected light from a scene or object, wherein the reflected light is generated by illuminating the scene or object with the optical effect. For example, the module 400 may emit light that interacts with an environment of the module 400 and is then received back by the module 400, allowing the module 400 to act, for example, as a proximity sensor or as a three-dimensional mapping device. The modules described above may be part of, for example, time-of-flight cameras or active-stereo cameras. The modules may be integrated into systems, for example, mobile phones, laptops, television, wearable devices, or automotive vehicles.

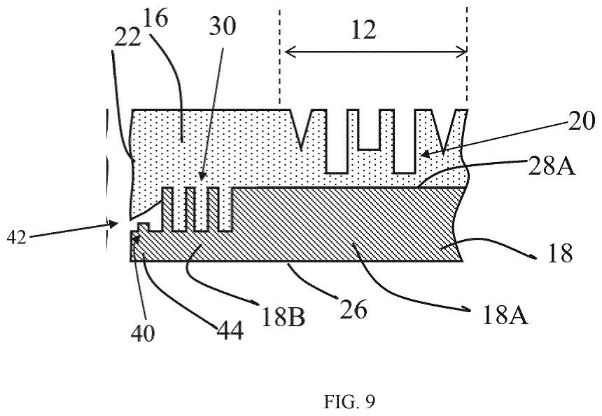

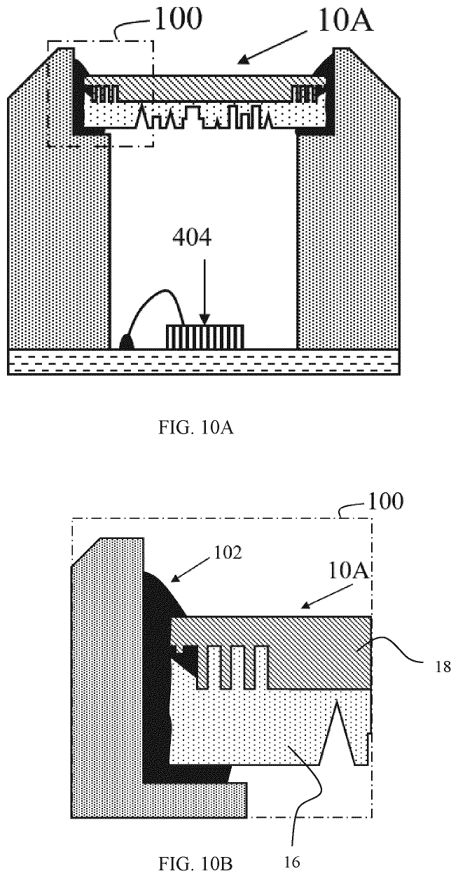

FIG. 9 illustrates another example of an optical element in which the structural features for increasing the overall surface area of the interface between the substrate 18 and the optical layer 16 include, as in the example of FIG. 3, trenches 30 in the upper surface of the second region 18B of the substrate 18. The substrate 18 has a short projection 40 located closer to the lateral side-surface 22 than are the trenches 30. The height of the projection 40 is less than the depth of the trenches 30. The presence of the trenches 30 can help increase the surface area at the interface between the substrate 18 and the optical layer 16, thereby reducing the likelihood that the optical layer will delaminate. On the other hand, the presence of the small projection 40 can allow the optical layer 16 to delaminate partially at its edge 42. Such partial delamination can be advantageous in some implementations to increase the surface area that is in contact with adhesive in a subsequent assembly (e.g. the module described below in connection with FIGS. 10A and 10B).

As illustrated in FIGS. 10A and 10B, the optical element of FIG. 9 (indicated by reference numeral 10A in FIGS. 10A and 10B) is integrated into an optoelectronic module that includes a light emitting or light-sensitive component 404 such as described above in connection with FIG. 8. As shown in the example of FIGS. 10A and 10B, the optical element 10A is held in place by adhesive 102 such that the optical element 10A is attached to the inner sidewalls of the module above the component 404. The partial delamination of the optical layer induced by the presence of the small projection 40 of the substrate 18 (see FIG. 9) can facilitate improved contact of the optical element 10A with the adhesive 102.

FIG. 11 illustrates another example of an optical element including structural features 46 for increasing the overall surface area of the interface between the optical layer 16 and the adjacent layer(s). However, in this example, the structural features 47 are formed on the upper surface 28A of the substrate 18. In particular, the structural features 46 can be provided on the second region 18B of the substrate 18 adjacent the lateral side-surface 22. In some implementations, the structural features 46 are composed of an amorphous or crystalline silicon film, and appear as small projections on the surface 28A of the substrate 18. The optical element of FIG. 11 also can be integrated into optical or optoelectronic systems including a device that is operable to emit or sense light at an operational wavelength k (see FIG. 8).

The following paragraphs describe techniques for fabricating optical elements as described above. The optical elements can be fabricated, for example, on a wafer scale in which multiple optical elements are fabricated in parallel. The techniques can include making modifications to the dicing track region of the substrate wafer prior to depositing the optical layer.

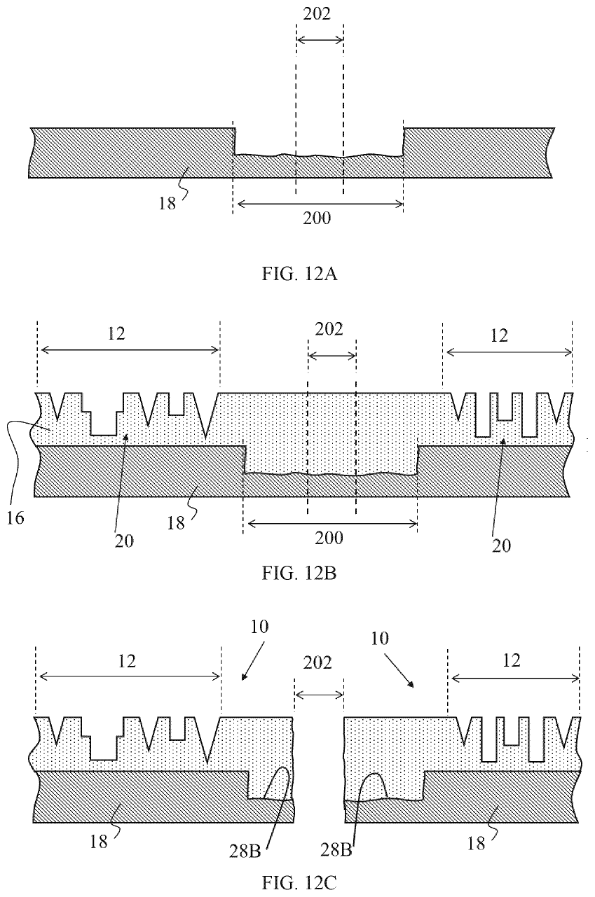

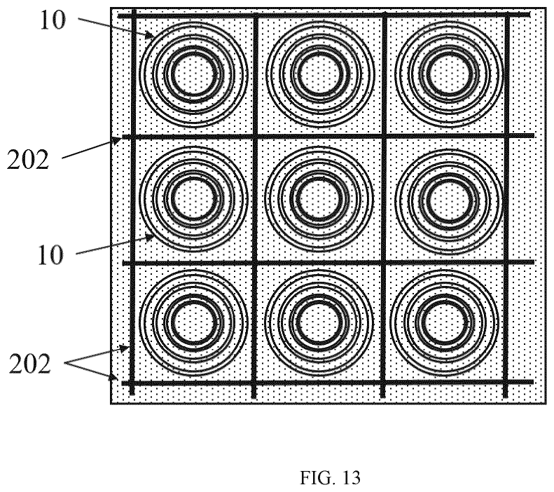

FIGS. 12A through 12C illustrate an example of a method for fabricating optical elements as in FIG. 2. As shown, for example, in FIG. 12A, a partial dicing is performed on the substrate wafer in areas 200 corresponding to locations for the dicing tracks (see dicing tracks 202 in FIG. 13). The width of the areas 200 on which the partial dicing is performed should be somewhat wider than the dicing tracks. The dicing blade for the partial dicing preferably is sufficiently coarse so as to increase the surface area and prevent delamination of the subsequently disposed optical layer. For example, in some instances, a dicing blade used for the partial dicing can be on the order of ten times as coarse as the dicing blade for subsequent singulation (e.g., dicing) of the optical elements. The result is that the thickness of the substrate wafer 18 in areas 200 where the partial dicing takes place is less than the thickness of the remaining parts of the substrate wafer 18. The substrate wafer 18 can be composed, for example, of glass, silicon (e.g., polysilicon or crystalline), or another suitably rigid material.

In a subsequent operation, as shown in FIG. 12B, an optical layer 16 is provided over the substrate wafer 18, and optical structures 20 (i.e., the optical structures within the optically active area 12) are formed in the optical layer. In some implementations, the optical layer 16 is composed of a polymeric material. In some instances, the optical layer 16 is a spun-on polymeric material (e.g., a micro resist), whereas in other instances the optical layer is a polymeric material that is jetted onto specific, predetermined areas of the wafer (e.g., areas of the wafer corresponding to the optically active areas 12 for the optical elements). In some instances, the optical layer 16 is applied by drop-casting. If the optical layer 16 is composed of a polymeric material, the optical structures 20 can be imprinted (e.g., via a nanoimprint lithography process).

In a subsequent operation, as shown in FIG. 12C, the substrate wafer is diced along dicing tracks (see FIG. 13) so as to separate the wafer into individual optical elements 10, such as those in FIG. 2.

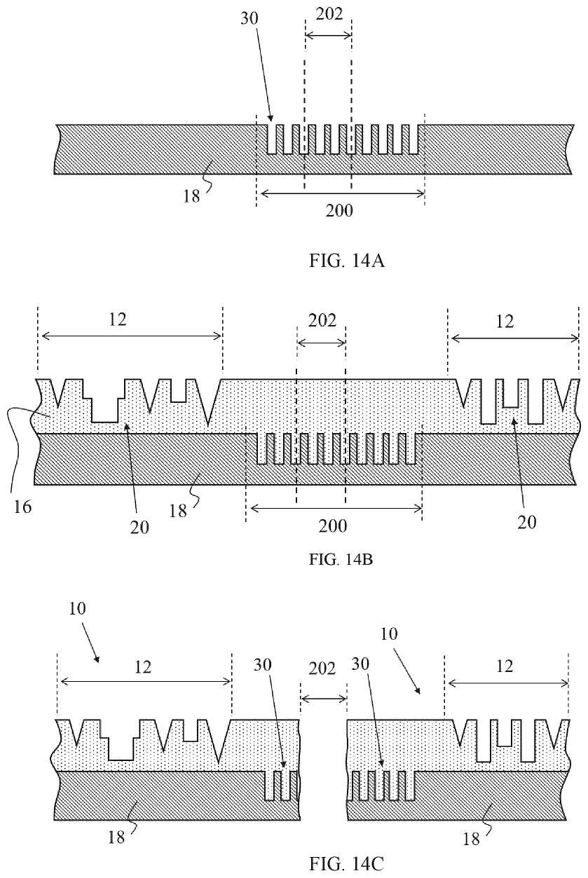

FIGS. 14A through 14C illustrate an example of a method for fabricating optical elements as in FIG. 3. As shown, for example, in FIG. 14A, trenches 30 are formed in the substrate wafer in areas 200 corresponding to locations for the dicing tracks (see dicing tracks 202 in FIG. 13). The width of the areas 200 in which the trenches 30 are formed should be somewhat wider than the dicing tracks. The substrate wafer 18 can be composed, for example, of glass, silicon (e.g., polysilicon or crystalline), or another suitably rigid material. In some instances, the trenches 30 are formed by etching (e.g., wet etching or dry etching) through a masking layer. For example, a masking layer can be applied to the substrate, the masking layer can be patterned using photolithography techniques, and the substrate wafer 18 then can be etched through the masking layer. In some cases, the trenches 30 can be formed by or inductively coupled plasma (ICP) etching. Each trench 30 can have a depth and width, for example, on the order of a few microns. In some cases, the depth of each trench 30 is greater than the width. The dimensions may vary in other implementations.

In a subsequent operation, as shown in FIG. 14B, an optical layer 16 is provided over the substrate wafer 18, and optical structures 20 (i.e., the optical structures within the optically active area 12) are formed in the optical layer. Details regarding composition and deposition of the optical layer 16, as well as formation of the optical structures, can be the same as or similar to those described in connection with FIG. 12B.

In a subsequent operation, as shown in FIG. 14C, the substrate wafer is diced along dicing tracks (see FIG. 13) so as to separate the wafer into individual optical elements 10, such as those in FIG. 3.

Techniques similar to those described in connection with FIGS. 14A through 14C also can be used to fabricate optical elements as shown in FIG. 9. In that case, however, multiple etches may be needed to obtain the structured features 30, 40 in the substrate 18.

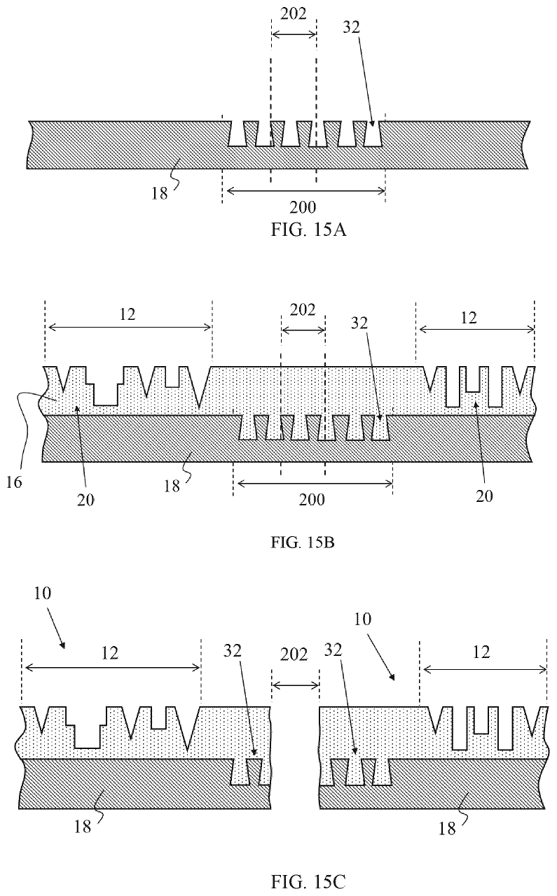

FIGS. 15A through 15C illustrate an example of a method for fabricating optical elements as in FIG. 4. As shown, for example, in FIG. 15A, undercut trenches 32 are formed in the substrate wafer in areas 200 corresponding to locations for the dicing tracks (see dicing tracks 202 in FIG. 13). The width of the areas 200 in which the trenches 32 are formed should be somewhat wider than the dicing tracks. The substrate wafer 18 can be composed, for example, of glass, silicon (e.g., polysilicon or crystalline), or another suitably rigid material. In some instances, the undercut trenches 32 are formed by reactive ion beam etching (RIE) or inductively coupled plasma (ICP) etching. In some cases, implementations using undercut trenches 32 be particularly robust. Thus, in some instances, the trenches 32 need not be as deep as in other embodiments to achieve the same degree of delamination prevention. Shallower trenches can achieve cost savings, in some cases, because etching deeper trenches often requires greater manufacturing costs.

In a subsequent operation, as shown in FIG. 15B, an optical layer 16 is provided over the substrate wafer 18, and optical structures 20 (i.e., the optical structures within the optically active area 12) are formed in the optical layer. Details regarding composition and deposition of the optical layer 16, as well as formation of the optical structures, can be the same as or similar to those described in connection with FIG. 12B.

In a subsequent operation, as shown in FIG. 15C, the substrate wafer is diced along dicing tracks (see FIG. 13) so as to separate the wafer into individual optical elements 10, such as those in FIG. 4.

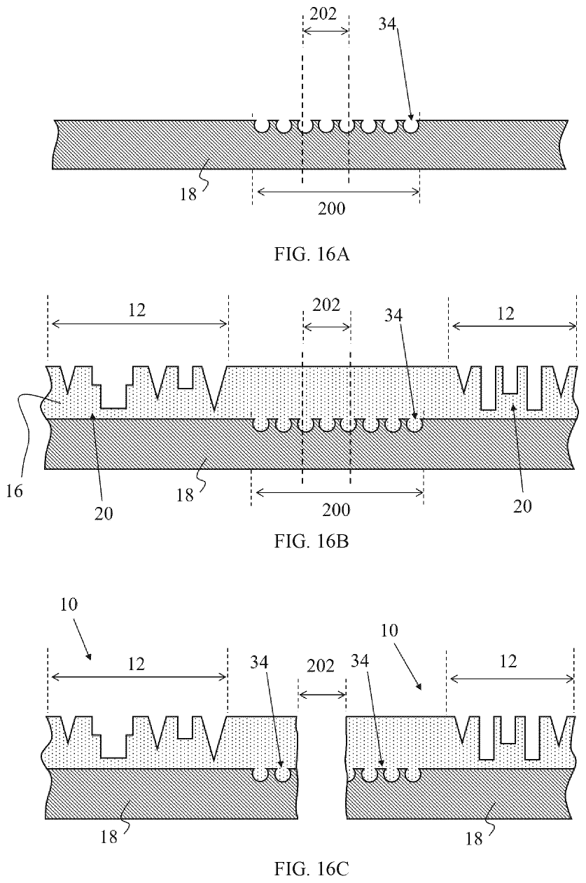

FIGS. 16A through 16C illustrate an example of a method for fabricating optical elements as in FIG. 5. As shown, for example, in FIG. 16A, undercut, curved-walled trenches 34 are formed in the substrate wafer in areas 200 corresponding to locations for the dicing tracks (see dicing tracks 202 in FIG. 13). The width of the areas 200 in which the trenches 34 are formed should be somewhat wider than the dicing tracks. The substrate wafer 18 can be composed, for example, of glass, silicon (e.g., polysilicon or crystalline), or another suitably rigid material. In some instances, the trenches 36 are formed by etching. For example, in some implementations, a masking layer is applied to the substrate, the masking layer is patterned using photolithography techniques, and the substrate wafer 18 then is etched through the masking layer. Preferably, the etchant has no affinity for the masking material in order to achieve undercut, curved-walled trenches. For example, in some instances, the etchant is hydrophilic, and the masking material is hydrophobic.

In a subsequent operation, as shown in FIG. 16B, an optical layer 16 is provided over the substrate wafer 18, and optical structures 20 (i.e., the optical structures within the optically active area 12) are formed in the optical layer. Details regarding composition and deposition of the optical layer 16, as well as formation of the optical structures, can be the same as or similar to those described in connection with FIG. 12B.

In a subsequent operation, as shown in FIG. 16C, the substrate wafer is diced along dicing tracks (see FIG. 13) so as to separate the wafer into individual optical elements 10, such as those in FIG. 5.

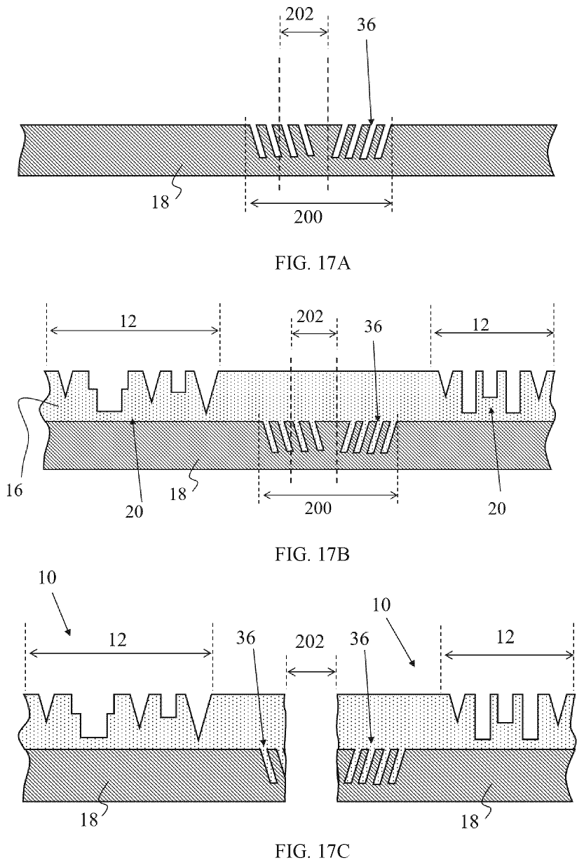

FIGS. 17A through 17C illustrate an example of a method for fabricating optical elements as in FIG. 6. As shown, for example, in FIG. 17A, canted straight-walled trenches 36 are formed in the substrate wafer in areas 200 corresponding to locations for the dicing tracks (see dicing tracks 202 in FIG. 13). The width of the areas 200 in which the trenches 36 are formed should be somewhat wider than the dicing tracks. The substrate wafer 18 can be composed, for example, of glass, silicon (e.g., polysilicon or crystalline), or another suitably rigid material. In some instances, the trenches 36 are formed by reactive ion beam etching (RIE) or inductively coupled plasma (ICP) etching.

In a subsequent operation, as shown in FIG. 17B, an optical layer 16 is provided over the substrate wafer 18, and optical structures 20 (i.e., the optical structures within the optically active area 12) are formed in the optical layer. Details regarding composition and deposition of the optical layer 16, as well as formation of the optical structures, can be the same as or similar to those described in connection with FIG. 12B.

In a subsequent operation, as shown in FIG. 17C, the substrate wafer is diced along dicing tracks (see FIG. 13) so as to separate the wafer into individual optical elements 10, such as those in FIG. 6. The canted trenches 36 can, in some instances, help prevent delamination of the optical layer 16 by counteracting the delamination torque.

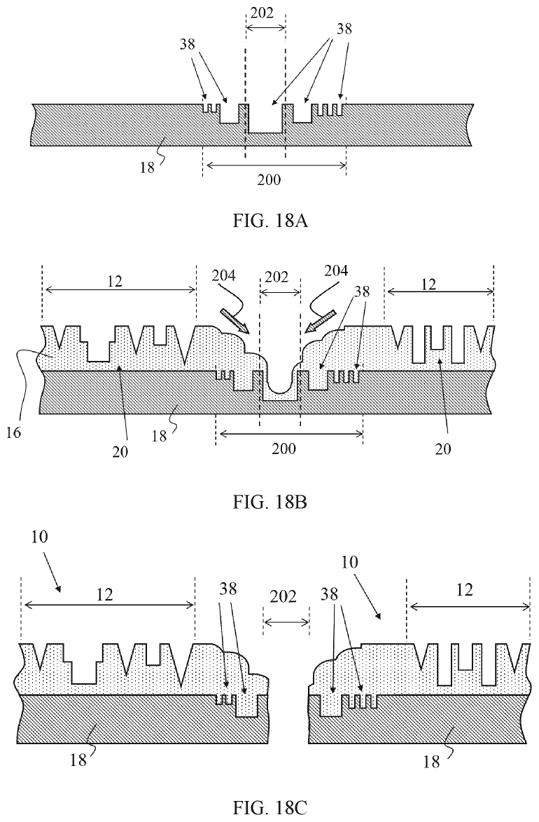

FIGS. 18A through 18C illustrate an example of a method for fabricating optical elements as in FIG. 7. As shown, for example, in FIG. 18A, straight-walled trenches 38 having different volumes from one another are formed in the substrate wafer in areas 200 corresponding to locations for the dicing tracks (see dicing tracks 202 in FIG. 13). The width of the areas 200 in which the trenches 38 are formed should be somewhat wider than the dicing tracks. The substrate wafer 18 can be composed, for example, of glass, silicon (e.g., polysilicon or crystalline), or another suitably rigid material. In some instances, the trenches 38 are formed by etching (e.g., wet or dry etching). In some implementations, trenches 38 in or closer to the region for the dicing track 202 have a larger volume than the trenches 38 further away from the dicing track, which can be advantageous during deposition of the material for the optical layer 16, as explained below.

In a subsequent operation, as shown in FIG. 18B, an optical layer 16 is provided over the substrate wafer 18, and optical structures 20 (i.e., the optical structures within the optically active area 12) are formed in the optical layer. Details regarding composition and deposition of the optical layer 16, as well as formation of the optical structures, can be the same as or similar to those described in connection with FIG. 12B. In instances where the material for the optical layer 16 is applied to particular optical areas, for example, by jetting, excess optical layer material can overflow into the larger trenches 38 that are closer to or in the region for the dicing track 202. This can allow sufficient optical layer material to be used so as to increase throughput, while allowing excess optical layer material to overflow in to the larger trench(es) 38.

In a subsequent operation, as shown in FIG. 18C, the substrate wafer is diced along dicing tracks (see FIG. 13) so as to separate the wafer into individual optical elements 10, such as those in FIG. 7.

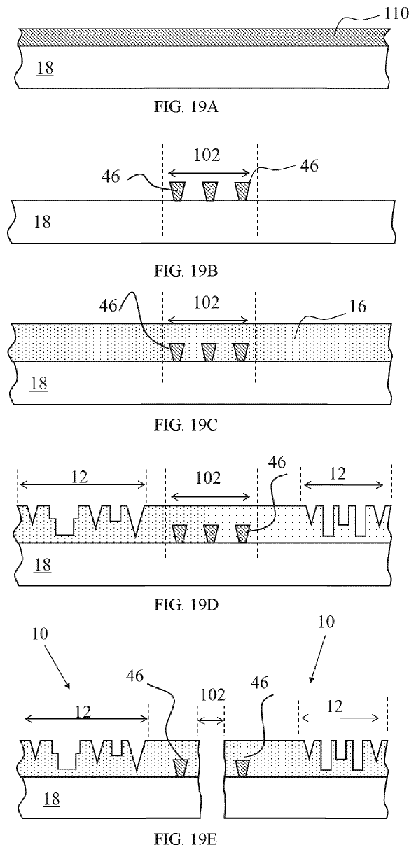

FIGS. 19A through 19E illustrate an example of a method for fabricating optical elements as in FIG. 11. As shown, for example, in FIG. 19A, a film 110 is deposited on the upper surface of the substrate 18, which can be composed of a suitably rigid material (e.g., glass). The film 110, which can be composed, for example, of amorphous or crystalline silicon, can be deposited using any of various deposition techniques (e.g., chemical vapor deposition). As shown in FIG. 19B, the film 110 is structured, for example, by a lithography process to form the structural features 46, which appear as small projections on the surface of the substrate 18.

In a subsequent operation, as shown in FIG. 19C, an optical layer 16 is provided over the substrate wafer 18 and over the structural features 46. As further shown in FIG. 19D, the surface of the optical layer 16 can be imprinted, for example, to form optical structures for the optically active areas 12. Details regarding composition and deposition of the optical layer 16, as well as formation of the optical structures, can be the same as or similar to those described in connection with FIG. 12B.

In a subsequent operation, as shown in FIG. 19E, the substrate wafer is diced along dicing tracks (see FIG. 13) so as to separate the wafer into individual optical elements 10, such as those in FIG. 11.

Forming the structural features 46 in a thin film 110 as described in connection with the implementation of FIGS. 19A-19E can be advantageous because the film 110 can be relatively thin. Consequently, the structural features 46 can be formed relatively, which in some cases, can reduce manufacturing time and costs. Further, etching an undercut in a film 110 of silicon material can be readily achieved to form structured features 46 shaped, for example, as an inverted frustum of a pyramid.

Various modifications may be made within the spirit of this disclosure. Accordingly, other implementations also are within the scope of the claims.

This listing of claims replaces all prior versions and listings of claims in the application:

1. An optical device comprising:
a substrate; and
an optical layer disposed on the substrate,
wherein a surface of the substrate that forms an interface with the optical layer is non-planar, and wherein an overall surface area of the interface is greater than if the surface of the substrate were planar.

2. The optical device of claim 1, wherein the substrate is composed of glass or silicon, and wherein the optical layer is composed of a polymeric material.

3. The optical device of claim 1, wherein a first region of the substrate has a first thickness, and wherein a second region of the substrate adjacent a lateral side-surface of the substrate has a second thickness that is less than the first thickness.

4. The optical device of claim 3, wherein the second region of the substrate is below an optically inactive area of the optical layer.

5. The optical device of claim 3, wherein the surface of the substrate in the second region is rougher than the surface of the substrate in the first region.

6. The optical device of claim 1, wherein the surface of the substrate includes one or more trenches.

7. The optical device of claim 6, wherein the one or more trenches are in a region of the substrate adjacent a lateral side-surface of the substrate.

8. The optical device of claim 6, wherein the one or more trenches include at least one undercut trench.

9. The optical device of claim 6, wherein the one or more trenches include at least one straight-walled trench.

10. The optical device of claim 6, wherein the one or more trenches include at least one curved-walled trench.

11. The optical device of claim 6, wherein the trenches include at least one canted straight-walled trench.

12. The optical device of claim 6, wherein the one or more trenches include a plurality of trenches, wherein a volume of at least one of the trenches differs from a volume of another one of the trenches.

13. The optical device of claim 6, wherein the surface of the substrate includes a projection located closer to a lateral side-surface of the substrate than are the one or more trenches, and wherein a height of the projection is less than a depth of the one or more trenches.

14. An optical device comprising:
a substrate;
one or more projections on a surface of the substrate, wherein the one or more projections are composed of a silicon film; and
an optical layer disposed on the surface of the substrate and on surfaces of the projections,
wherein the optical layer has a first region that is structured so as to provide an optical effect on light impinging on the first region, the optical layer further including a second optically inactive region that is closer to a lateral side-surface of the substrate, wherein the one or more projections are disposed below the second optically inactive region of the optical layer.

15. The optical device of claim 14, wherein the substrate is composed of glass, and wherein the optical layer is composed of a polymeric material.

16. The optical device of claim 14, wherein each of the one or more projections has a shape of an inverted frustum of a pyramid.

17. An optoelectronic assembly comprising:
an optoelectronic component;
a housing; and
an optical device according to claim 1,
wherein the optical device is aligned with the optoelectronic component and is mounted to the housing.

18. The optoelectronic assembly of claim 17 wherein:
the surface of the substrate includes one or more trenches;
the surface of the substrate includes a projection located closer to a lateral side-surface of the substrate than are the one or more trenches, a height of the projection being less than a depth of the one or more trenches; and
the optical device is attached to the housing by an adhesive material, the adhesive material being in contact with the projection.

19. The optoelectronic assembly of claim 18, wherein some of the adhesive material is disposed between the projection and the optical layer.

20. The optoelectronic assembly of claim 18, wherein the optoelectronic component comprising at least one of a light emitter or light sensor.
